(19) United States
(12) Patent Application Publication
(10) Pub. No.: US 2013/0081975 A1
(43) Pub. Date: Apr. 4, 2013

(54) Gripping Utensil Kit

(71) Applicant: Elizabeth Lincoln, Mt. Carroll, IL (US)

(72) Inventor: Elizabeth Lincoln, Mt. Carroll, IL (US)

(21) Appl. No.: 13/249,879

(22) Filed: Sep. 30, 2011

(51) Int. Cl. B66C 1/42; B65D 71/00; B66C 1/00

(52) U.S. Cl. 206/575; 294/86.4; 294/118; 294/92

(57) ABSTRACT

A gripping utensil kit comprising a set of gripping utensils, where the set of gripping utensils includes at least one clamp to manipulate a piece of material; and a case to contain the set of gripping utensils, wherein the case enables a user to transport and store the set of gripping utensils so the set of gripping utensils are readily available for the user. The gripping utensil kit may include a forceps, a blunt tip clamp and a serrated tip clamp.

### BACKGROUND OF THE INVENTION

1. Field of the Invention

The present invention relates to a craft kit used for sewing wherein the craft kit includes various styles of gripping utensils to assist a user to manipulate fabric.

2. Description of Related Art

Crafting is a popular hobby enjoyed by young and old alike either as a pleasurable pastime or as a profitable business venture. Various tools and equipment are utilized each serving a specific purpose for the crafters needs. For example, sewers may utilize pins to mark where a stitch or hem is required or a thimble to protect their fingers from a prick of a needle. Often while working with fabrics the craftsman requires manipulating the fabric in specific way so as to line up the precise direction for sewing or fastener placement. To do this the craftsman may use pins, clips or frames to temporarily direct the fabrics and thread. Many times the holding tools are stubby leading to imprecise grasps, or the tools contain weak grasp resulting in fabric movement, damage and errors.

In a completely different field of item manipulation, surgeons often utilize tools during surgery to manipulate human tissue into exact placement to enable them to access the precise location where they need to operate. These manipulation tools are often stainless steel instruments made with finely tuned precision to serve the exact purpose for which they were created. For example, forceps are a handheld, hinged instrument used for grasping and holding objects. Many types of forceps or clamps have the appearance of a pair of scissors and are operated the same. Rather than cutting through materials like scissors, the forceps are used to grasp or pinch an item, and may be locked in a pinched position as desired by the surgeon. Since surgery requires the most precise and accurate tissue manipulation, the tools used are also held to such an elevated standard.

It would be desirable in the art to provide a set of crafting tools that provide a stronger grip and more precise means of fabric manipulation. It would also be beneficial in the art to provide a craft kit wherein the tools are fashioned after surgical tools, yet made from cheaper materials so as to be accessible to the common consumer.

### SUMMARY OF THE INVENTION

In view of the foregoing disadvantages inherent in the prior art, the general purpose of the present invention is to provide a gripping utensil kit, configured to include all of the advantages of the prior art, and to overcome the drawbacks inherent therein.

Accordingly, an object of the present invention is to provide a craft kit that combines various surgical style tools to assists a user when directing a piece of material.

Another object of the present invention is to provide a craft kit that includes various types of clamps for specific fabric manipulation.

To achieve the above objects, in an aspect of the present invention, a gripping utensil kit is described comprising a set of gripping utensils, where the set of gripping utensils includes at least one clamp to manipulate a piece of material; and a case to contain the set of gripping utensils, wherein the case enables a user to transport and store the set of gripping utensils so the set of gripping utensils are readily available for the user. The gripping utensil kit may include a forceps, a blunt tip clamp and a serrated tip clamp.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a pair of forceps in accordance with an exemplary embodiment of the present invention;

FIG. 2 depicts a perspective view of a blunt grip clamp in accordance with an exemplary embodiment of the present invention;

FIG. 2(A) depicts an enlarged view of an end of a blunt grip clamp in accordance with an exemplary embodiment of the present invention;

FIG. 3 depicts a perspective view of a serrated tip clamp in accordance with an exemplary embodiment of the present invention;

FIG. 3(A) depicts an enlarged view of an end of a serrated tip clamp in accordance with an exemplary embodiment of the present invention; and

FIG. 4 depicts a perspective view of a gripping utensil kit in accordance with an exemplary embodiment of the present invention.

Like reference numerals refer to like parts throughout the description of several views of the drawings.

### DETAILED DESCRIPTION OF THE DRAWINGS

The present invention provides a gripping utensil kit that includes various types of surgical style clamps to serve the needs of enhanced precision for a craftsman. Made from quality materials that provide a strong grip and secure hold, the gripping utensil kit employs the concepts of elongated clamps constructed with ridged jaws to assist in grabbing and securely locking fabrics without damaging delicate weaves or designs during use. Specifically, the clamps included instruments modeled after the surgical Kelly Clamp, Allis Clamp and Peon Clamp, ideal for the novice and professional crafter when completing a myriad of art projects.

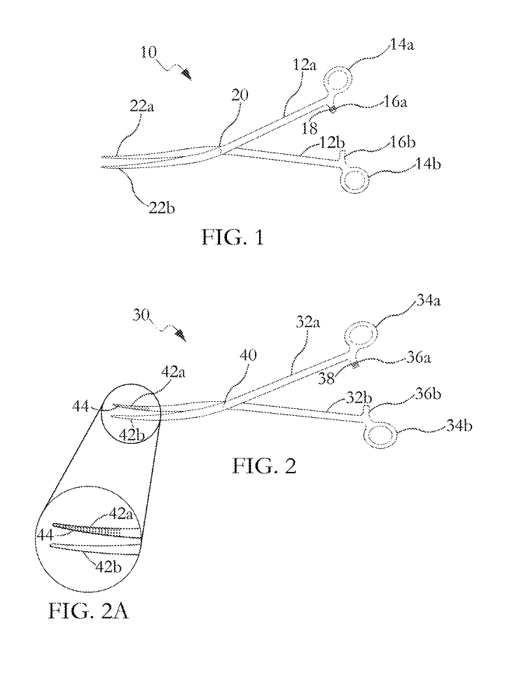

Turning now descriptively to the drawings, referring to FIG. 1, a perspective view of a pair of forceps (10) is shown in accordance with an exemplary embodiment of the present invention. The forceps (10) may generally have the appearance of a pair of scissors, but rather than sharp blades at the engaging end of the scissors, the forceps (10) includes a pair of tips (22a, 22b) (hereinafter tips) utilized for gripping rather than cutting. The forceps (10) are modeled after a pair of surgical forceps, specifically a Peon Clamp. The forceps (10) may be made from a hardened steel, molded plastic or another strong and durable material known and used in the art able to withstand the repeated gripping and locking endured by the instrument. The length of the forceps (10) may range from 3 inches to 10 inches, accommodating the various needs of the user.

The forceps (10) includes a pair of arms (12a, 12b) (hereinafter arms) that extend the entire length of the forceps (10). The arms (12a, 12b) intersect at along a middle portion, and are connected at a pivot (20). The arms (12a, 12b) rotate about each other at the pivot (20) to enable the arms (12a, 12b) to open and close. The arms (12a, 12b) may be curved (as shown) or straight, depending on the uses, likes and needs preferred by the user.

At a first end of the arms (12a, 12b) is a pair of finger loops (14a, 14b) (hereinafter finger loops). The finger loops (14a, 14b) receive a user's fingers, specifically the thumb and middle finger, to operate the forceps (10). The finger loops (14a, 14b) may be covered with a soft material to provide a more comfortable feel against the user's fingers especially after repeated use. The soft material may be a rubber, plastic or gel filled substance.

Next to the finger loops (14a, 14b) is pair of small protrusions that serve as a locking mechanism (16a, 16b) for the forceps (10). The locking mechanism (16a, 16b) includes a set of engaging teeth (18) to fasten the locking mechanism (16a, 16b) together. The engaging teeth (18) of the locking mechanism (16a, 16b) secure the arms (12a, 12b) together in a closed position when the user presses the finger loops (14a, 14b) close together. To release the locking mechanism (16a, 16b) the user simply separates the engaging teeth (18) and moves the arms (12a, 12b) away from each other into an open position.

Turning now to the second end of the arms (12a, 12b) are the pair of tips (22a, 22b). The tips (22a, 22b) are the clamping or gripping portion of the forceps (10). When the user opens the forceps (10) the tips (22a, 22b) separate, and in turn come together when the user squeezes the finger loops (14a, 14b). As such, the tips (22a, 22b) are locked together when the locking mechanism (16a, 16b) is engaged to secure the blunt tips (22a, 22b) against a piece of material, thereby preventing the material from slipping or sliding from between the pair of tips (22a, 22b).

Referring to FIG. 2 a perspective view of a blunt grip clamp (30) is shown in accordance with an exemplary embodiment of the present invention. The blunt grip clamp (30) is structured and operationally similar to the forceps (10) including a pair of arms (32a, 32b), a pair of finger loops (34a, 34b), a locking mechanism (36a, 36b), a set of engaging teeth (38) and a pivot (40). Likewise, the pair of arms (32a, 32b) of the blunt tip clamp (30) may be straight (as shown) or curved depending on the preferred style of the use, and the materials used are similar to those used for the forceps (10).

The blunt grip clamp (30) is shaped and modeled after a surgical clamp commonly known as a Kelly Clamp, distinct due to ridges or grips along the gripping portion of the tips (42a, 42b). The tips (42a, 42b) include a plurality of textured grips (44) (hereinafter textured grips) to securely grasp the material placed within the gripping portion. FIG. 2(A) shows an enlarged view of the textured gripping portion to better illustrate the tips (42a, 42b) and the textured grips (44). The textured grips (44) may extend from the tips (42a, 42b) up towards the pivot (40) to ensure that the material inserted between the tips (42a, 42b) does not slide or slip out during use.

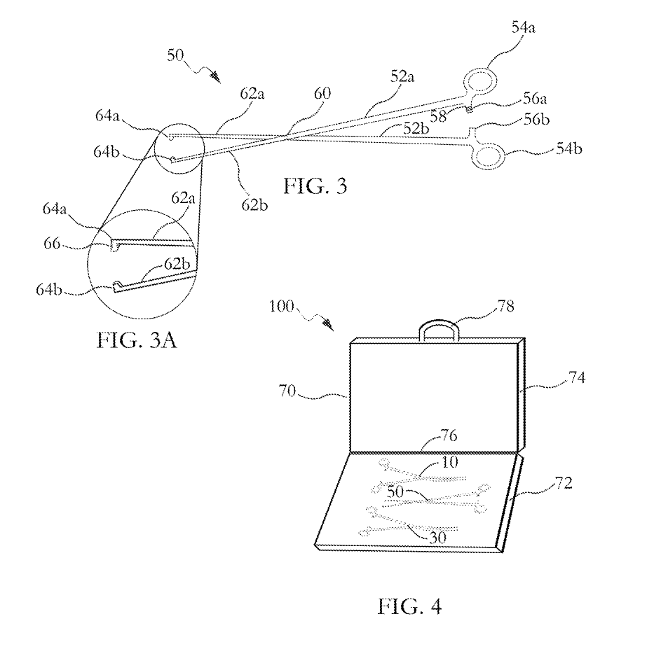

Referring to FIG. 3 a perspective view of a serrated tip clamp (50) is shown in accordance with an exemplary embodiment of the present invention. The serrated tip clamp (50) is again structured and operationally similar to the forceps (10) including a pair of arms (52a, 52b), a pair of finger loops (54a, 54b), a locking mechanism (56a, 56b), a set of engaging teeth (58) and a pivot (60). The serrated tip clamp (50) is modeled after another surgical clamp commonly known as an Allis Clamp. Again, the pair of arms (52a, 52b) of the serrated tip clamp (50) may be straight (as shown) or curved depending on the preferred style of the use and made from similar materials as the forceps (10) and blunt tip clamp (30).

The gripping portion of the serrated tip clamp (50) includes a pair of ends (62a, 62b) (hereinafter ends) with a pair of modified tips (64a, 64b) (hereinafter tips). At the ends (62a, 62b) the arms (52a, 52b) bend towards each to simply meet at the tips (64a, 64b) when in the closed position. The tips (64a, 64b) may provide a more precise closure than the blunt grip clamp (30) by only providing a small gripping portion than the larger gripping portion of both the forceps (10) and the blunt grip clamp (30). FIG. 3(A) shows an enlarged view the tips (64a, 64b) to better illustrate a plurality of interlocking teeth (66) (hereinafter interlocking teeth) at the end of the tips (64a, 64b). The interlocking teeth (66) secure the material between the tips (64a, 64b) to ensure that the material does not slip or slide.

FIG. 4 depicts a perspective view of a gripping utensil kit (100) in accordance with an exemplary embodiment of the present invention. The gripping utensil kit (100) assembles a set of gripping utensils or tools (10, 30, 50) into a convenient storage case (70). The storage case (70) ensures that the tools are always together and prevents the user from losing them. The storage case (70) may include a base (72) upon which to rest or set the tools (10, 30, 50). The base (72) may be foam lined to prevent the tools (10, 30, 50) from hitting each other and damaging when being transported or stored in the storage case (70). Attached to a back wall of the base (72) may be a lid (74) attached at a hinge (76). Finally, the storage case (70) may include a handle (78) for easy transport and portability. The gripping utensil kit (100) enables a user to have numerous options for manipulating fabric depending on their particular needs and desires.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. (canceled)

2. (canceled)

3. (canceled)

4. (canceled)

5. (canceled)

6. (canceled)

7. (canceled)

8. (canceled)

9. (canceled)

10. (canceled)

11. A gripping utensil kit for use in fabric manipulation comprising:
a set of gripping utensils, where the set of gripping utensils includes a forceps, a blunt tip clamp and a serrated tip clamp, where each utensil is designed to manipulate a piece of fabric material and is made of a non-abrasive plastic material; and
a case to contain the set of gripping utensils, wherein the case enables a user to transport and store the set of gripping utensils and said case is foam lined.

12. The gripping utensil kit according to claim 11, wherein the forceps comprises:
a pair of arms extending the length of the forceps, where the pair of arms are attached at a pivot to open and close;
a pair of finger loops at a first end of the pair of arms, where a user inserts their fingers into the pair of finger loops to manipulate the pair of arms;
a pair of tips at a second end of the pair of arms, where the pair of tips grasp the piece of material; and
a locking mechanism positioned next to the pair of finger loops, where the locking mechanism secures the pair of tips together during use.

13. The gripping utensil kit according to claim 11, wherein the blunt tip clamp comprises:
a pair of arms extending the length of the blunt tip clamp, where the pair of arms are attached at a pivot to open and close;
a pair of finger loops at a first end of the pair of arms, where a user inserts their fingers into the pair of finger loops to manipulate the pair of arms;
a pair of tips at a second end of the pair of arms, where the pair of tips grasp the piece of material;
a plurality of textured grips along the pair of tips, where the plurality of textured grips secures the piece of material in place during use; and
a locking mechanism positioned next to the pair of finger loops, where the locking mechanism secures the pair of tips together during use.

14. The gripping utensil kit according to claim 11, wherein the serrated tip clamp comprises:
a pair of arms extending the length of the blunt tip clamp, where the pair of arms are attached at a pivot to open and close;
a pair of finger loops at a first end of the pair of arms, where a user inserts their fingers into the pair of finger loops to manipulate the pair of arms;
a pair of tips at a second end of the pair of arms, where the pair of arms curve at the second end and meet only at an end of the pair of tips;
a set of interlocking teeth at the end of the pair of tips, where the set of interlocking teeth secure the piece of material between the pair of tips during use; and
a locking mechanism positioned next to the pair of finger loops, where the locking mechanism secures the pair of tips together.
